(19) United States
(12) Patent Application Publication
(10) Pub. No.: US 2003/0063130 A1
(43) Pub. Date: Apr. 3, 2003

(54) Reproducing apparatus providing a colored slider bar

(76) Inventors: Mauro Barbieri, Eindhoven (NL); jan Alexis Daniel Nesvadba, Eindhoven (NL); Gerhardus Engbertus Mekenkamp, Eindhoven (NL); Marco Paolo Ceccarelli, Eindhoven (NL); Wilhelmus Franciscus Johannes Fontijn, Eindhoven (NL); Ronald Marcel Tol, Eindhoven (NL)

Correspondence Address: U S Philips Corporation, Intellectual Property Department, 580 White Plains Road, Tarrytown, NY, 10591, US

(21) Appl. No.: 10/129,693

(22) PCT Filed: Sep. 6, 2001
(86) PCT No.: PCT/EP01/10338

(30) Foreign Application Priority Data
Sep. 8, 2000 (EP) 00203096.3
Feb. 15, 2001 (EP) 01200540.1
May 11, 2001 (EP) 01201756.2

(51) Int. Cl. G09G 5/00

(52) U.S. Cl. 345/833; 345/716; 345/721; 345/589

(57) ABSTRACT

An apparatus for reproducing an ordered information unit, such as a TV program. The apparatus comprises a presentation unit (6) for generating a length display of the information unit on a display unit. The length display is divided in consecutive portions. A portion corresponds to a position in the information unit. The length display further comprises a marker. The apparatus further comprises a user operable input unit (8) for receiving commands to move the marker along the consecutive portions, means (10) for determining the portion at which the marker is located, and means (12) to enable reproduction of the information unit at the position indicated by the determined portion. A portion of the length display has at least one visual parameter. The visual parameter represents a parameter which is determined from at least a part of the information unit corresponding to said portion.

The invention relates to an apparatus for reproducing an ordered information unit. Said apparatus having presentation generator means for generating a length display of the information unit on a display unit, said length display being divided in consecutive portions, a portion corresponds to a position in the information unit, the apparatus further comprises user operable input means for receiving commands for moving a marker along the consecutive portions, means for determining the portion at which the marker is located, and means to enable reproduction of the information unit at the position indicated by the determined portion.

An apparatus defined above is known from “Video and Image processing in multimedia systems”, Borko Furht, Kluwer Academic publisher, 1995. A video player is described having a scroll bar. The length of the scroll bar represents the duration of the video program. A slider in the scroll bar displays the position of the actually displayed image in the video program. By moving the slider in the scroll bar a user can quickly jump to any position in the video program. The same principle is used in computer programs for displaying video clips or audio tracks. The slider shows the temporal or the relative position in the clip, track or program.

Advanced set-top boxes equipped with hard-disks, optical disk recorders and hand-held devices with large storage capacity are appearing on the market, making people eager to collect and create their own personal audio-video archives. But because from the point of view of the end user, the usefulness of a multimedia database is measured by the retrieval facilities it supports, proper tools for audio-video content navigation and search have to be provided.

It is an object of the invention to provide an apparatus for reproducing an ordered information unit having improved facility to find a specific location in said information unit.

The apparatus in accordance with the invention is characterized in that a portion of the length display has at least one visual parameter, said visual parameter representing a parameter having a relationship with at least a part of the information unit corresponding to said portion.

The invention is based on the following recognition. Accessibility is a key feature in consumer electronics products that involve data storage. Thus, user interaction is as important as the functionality of the device that manages the data. Sometimes users want to browse the video without even having a specific goal in mind. Besides the normal linear way of watching a program, they want just to have “content driven zapping”within programs. Video recorders based on hard disks have the advantage that they allow for immediately random access. Random access makes it possible to jump immediately to a specific position in a video program. Slider bars have been used to select a position to start playing from. The background of the prior art slider bar has only one color. In the event a user wants to find a specific location in the ordered information unit, such as a video program, he has to know the position in time in the video program. However the user normally knows not exactly the position in time but he usually knows more about the location that he wants to find. As an example we assume that the video program is a recorded football match. Normally, the football match is interrupted by commercials. Further, if a goal is scored, the sound intensity will increase. In this example the user knows something the kind of background of the scene he is looking for, the sound intensity of the scene, the length of the scene, the players playing in the scene, etc. All these characteristics of parts of the program can, separately or combined, be used as a parameter. The background color of the length display in accordance to the invention is determined from at least one of these parameters. By giving the portions of the slider bar a visual parameter that corresponds to at least one of these parameters, the user will find a specific location in a video program more quickly. As a user normally roughly knows the position of the desired scene in time, together with the visual parameter related to a characteristic of the video scene, he can find said scene more precisely. In a preferred embodiment of the invention the visual parameter is a color on a display unit. The color of a portion of the scroll bar could be the average color of an image at the position in the video program corresponding to said portion. However, there are other suitable methods to determine a color parameter from one or more video images. In the given example of the football match, the average color will be green for the portions related to the football match and will normally have another color for the portions related to the interruptions. With the color information in the background of the scroll bar the user is able to jump find easily the beginning of the parts of the football match. As indicated before, the audio also comprises information for the user to enable him to find a position in de video program. The parts of the scroll bar, which correspond to positions in the video program with a low audio level, could be colored green. The parts with a high audio level could be colored red. Other choices of colors or more colors could be suitable as well.

In another embodiment of the apparatus, the apparatus is characterized in that the apparatus further comprises means for determining the at least one visual parameters of the consecutive portions from the information unit. Preferably, the visual parameter of the portions is determined during the recording of the video information unit. Automatically extracted content descriptors of the video and audio signals, e.g. the dominant colors and the volume of the sound-track, could be coded using colors and displayed as vertical colored stripes in the background of a slider allowing intuitive access and content-driven navigation through stored video material.

In another embodiment of the apparatus, the apparatus is characterized in that the apparatus further comprises means for receiving the at least one visual parameters of the consecutive portions via a transmission medium. The visual parameter of the portions is now determined externally and could be transmitted simultaneously with the broadcasting of the information unit. However, the visual parameters could be obtained via, for example the internet. In the last situation it might be possible to receive visual parameters of the portions that could only determined off-line or even only by human beings, such as the type of scene (action, dialog, activity of person, etc).

Embodiments of the invention will now be described in more detail, by way of example, with reference to the drawings, in which

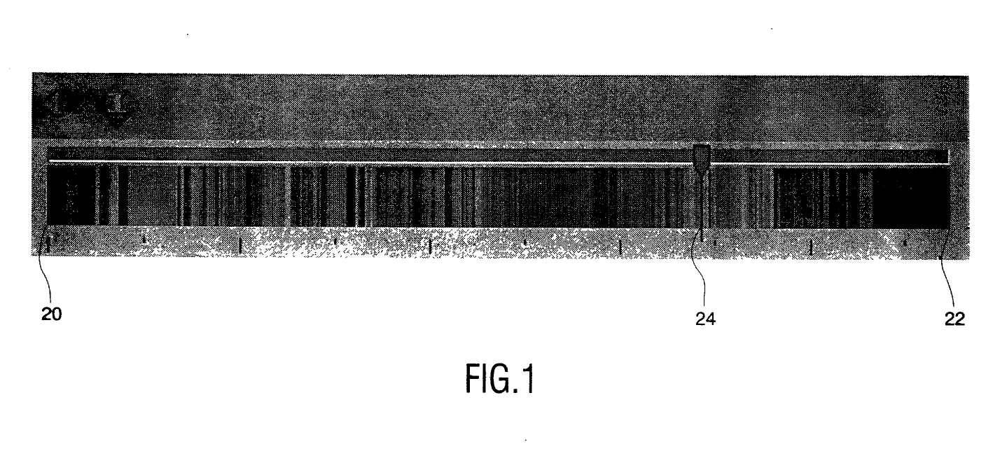

FIG. 1 shows an embodiment of a scroll bar in accordance with the invention,

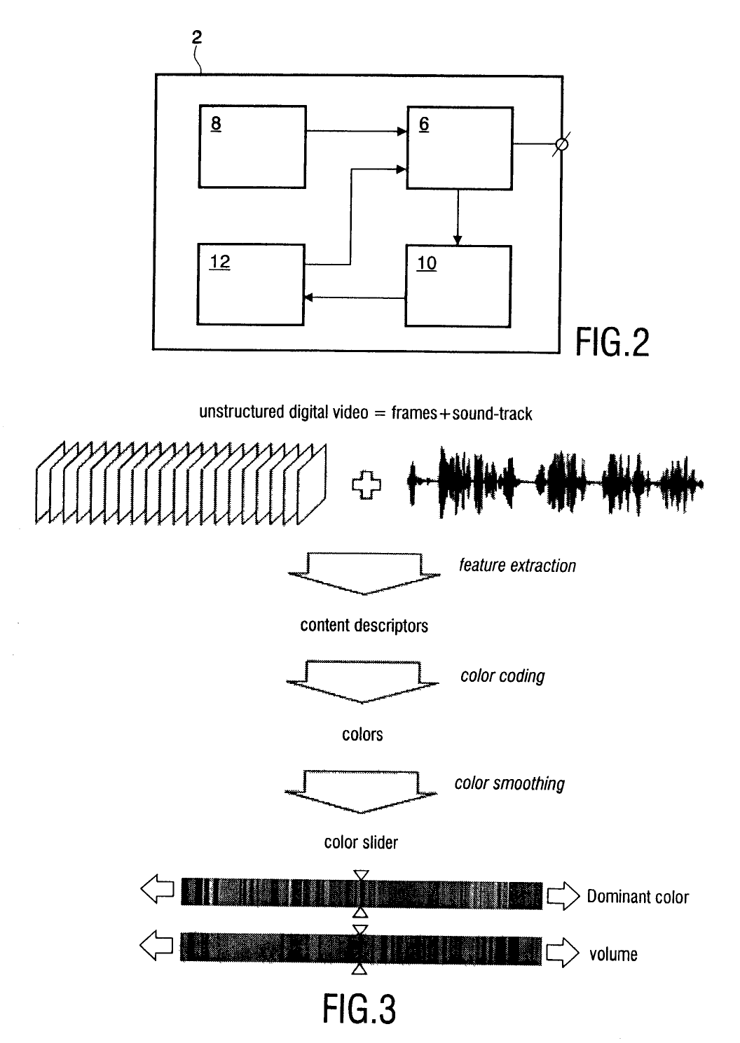

FIG. 2, shows an embodiment of an apparatus in accordance with the invention,

FIG. 3 shows a method to obtain a color slider from digital video,

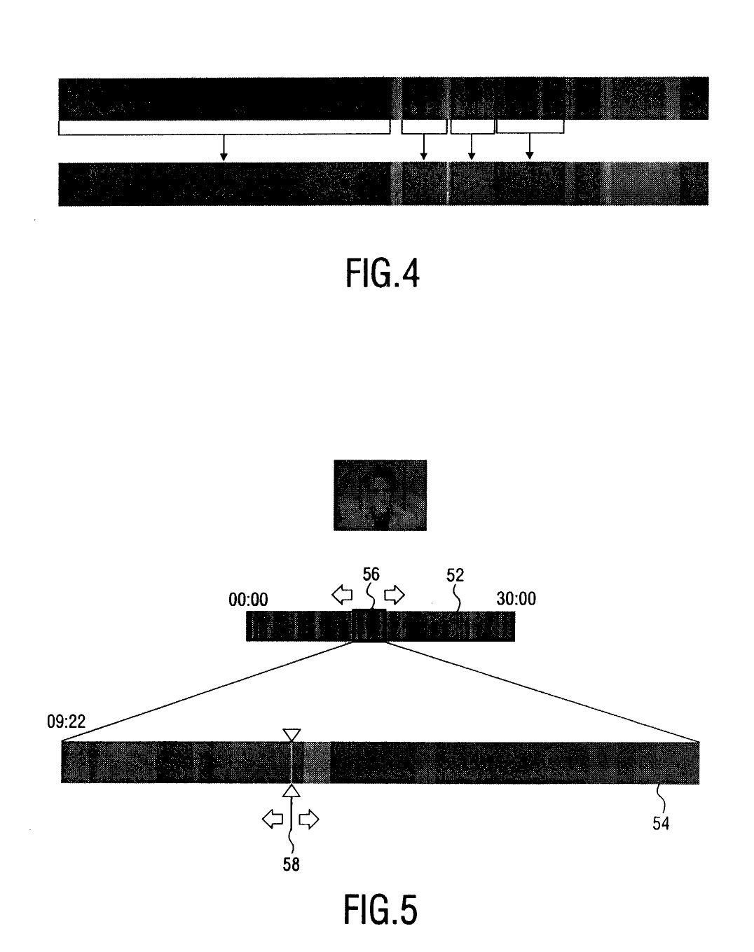

FIG. 4 shows the result of smoothing a color slider,

FIG. 5 shows an embodiment of color browser having two slider bars,

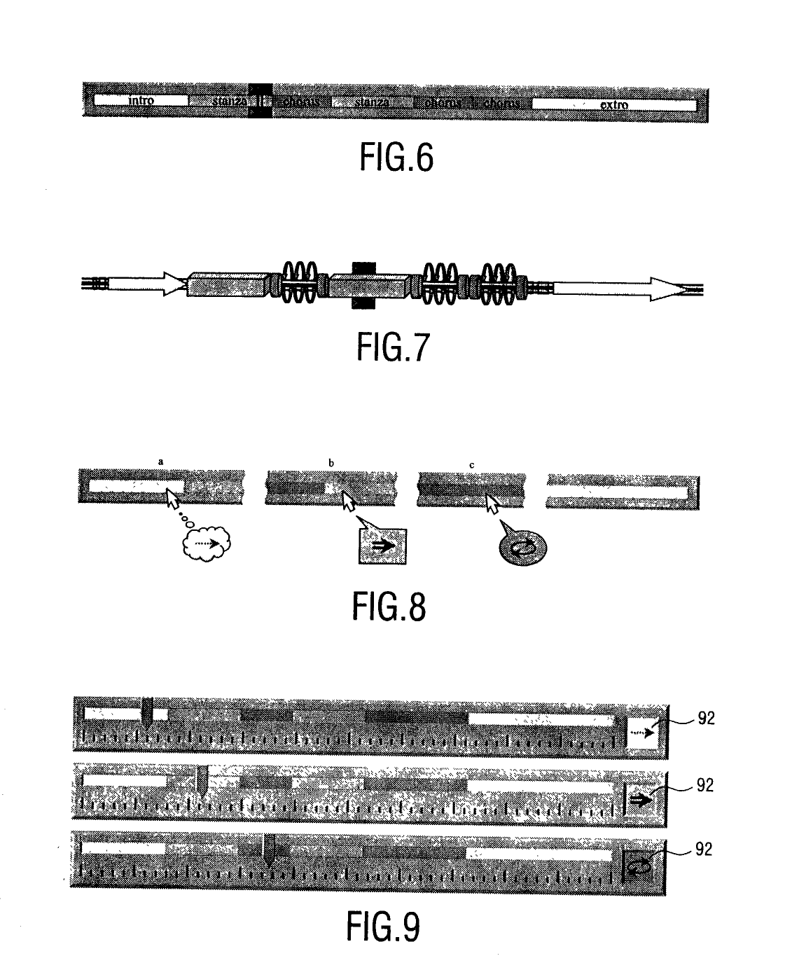

FIG. 6 shows an embodiment of an audio slider bar having the visual indicators superimposed on the slider,

FIG. 7 shows an embodiment of an slider bar which offer near limitless freedom when shaping the slider bar in line with the features in the information signal,

FIG. 8 shows a first embodiment of a dynamic visual slider bar, and

FIG. 9, shows a second embodiment of a dynamic slider bar.

FIG. 1 shows an embodiment of a length display. The left side 20 of the length display represents the beginning of the information unit and the right side 22 of the length display represents the beginning of the information unit. Further the length display comprises a slider 24. The slider represents the position of the information that will be read from the information unit. The background of the length display is used to give further information about the content of the information unit. The background is divided into vertical strips. Each vertical strip represents a part of the information unit, for example 10 seconds the TV program, and has a color, which may be a true color or a grey scale color.

The color has a relationship with the content of the corresponding part of the information unit. In the case the information unit is a TV program, the color of a vertical strip can be obtained by determining the average color of the first image of the part of the TV program corresponding to said vertical strip. Another suitable method to obtain the color is the dominant color algorithm. The color information in the background allows the user for example to see where a break in a recorded football match, since most of the images slider's background will be green because the dominant color of most images is green. During a break the colors will change drastically. In a similar way, commercial breaks can be found in a recorded movie.

Alternative content information that can be represented is, e.g. the audio level.

Marking the loudness with colors ranging (e.g.) from yellow to red. The red parts indicating the loudest scenes. This method has been found very useful for finding the most interesting parts of a football match, as the volume of the reporter is high during a goal or when a chance is missed.

FIG. 2 shows an embodiment of an arrangement in accordance with the invention. The arrangement 2 could be in the form of video recorder or a set-top box for receiving, recording and reproducing video programs. An output of the arrangement 4 is coupled to a display unit, not shown, for outputting a signal to be displayed such as the video program, on screen display information. However, the arrangement could also be in the form of a combination of both the set-top box and display unit. The arrangement comprises means for reading a video program from a storage medium, not shown. The storage medium could be fixed, such as a Hard Disk, or removable, such as a disk such DVD or DVR. On the storage medium at least one information unit is stored. The information unit can be any type of sequential information, for example a TV program or an audio track. An information unit may be the content of a broadcast recorded during one recording session, but could also be the whole content of a DVD disk. In the following description an information unit will be a TV program.

The arrangement comprises a presentation generation unit 6 for generating a length display of the TV program. The background of the length display is read from a storage medium 12, which is preferably the storage medium on which the TV program is stored. The background of the time length display is preferable generated and stored in said storage medium during recording of the TV program. For that the arrangement may comprise analyzing means for analyzing consecutive parts of the TV program to determine at least one parameter from the images, the audio material, the content descriptions or teletext information corresponding to said parts. For example, the dominant or average colors may be computed for every n-th I frame in an MPEG stream. The determined parameters are used to generate the color of a strip in the background of the length display. A part of the TV program represents preferably 10 to 30 seconds of the TV program. Automatically extracted content descriptors of the video and audio signals, e.g. the dominant colors and the volume of the sound-track, are coded using colors and displayed as vertical colored stripes in the background of a slider allowing intuitive access and content-driven navigation through stored video material.

However, it might be possible that a service provider supplies on request a background to be used in the time length display. In this case the background could comprise other information related to the part of the TV program, such as: persons playing, the kind of action (walking, driving, swimming, etc), place of action (home, car, park, etc). The background could be obtained by downloading from the Internet or a server from a service provider. However, the background color of the strips could be part of the broadcast signal carrying the TV program. If the background is transmitted simultaneously with the TV program the apparatus does not necessarily need the analyzing unit.

The arrangement further comprises user operable input means 8 for receiving commands for moving a slider 24 or marker along length display. The user operable input means could be in the form of a remote control having the buttons move left and right. However, any other suitable input device could be used to move the slider, such as mouse, joystick. The arrangement comprises a unit 10 for determining the location of the slider in the time length display. The location is used to obtain the corresponding position in the TV program. Said position is supplied to the reading means to start the reproduction of the TV program from said position. The apparatus enables the user to browse through the TV program. The background of the length display gives the user some additional information about the video content. Said additional information enables the user to see the parts of the TV program having certain characteristics and to find more quickly the scene he wants to see.

The representation of content information by using colors is useful to present low level information about the video and audio material to the user. The colored background enables the user to find interesting parts. Since the detection of interesting parts is not done by an algorithm but left to the user, the detection cannot fail. If the user does not select immediately the part he is looking for, he most probably has selected a part of the information that is also interested for him.

FIG. 3 shows the method to obtain the color slider. Every group of n contiguous video frames has associated a color that encodes a specific description of the content. These colors are represented as vertical stripes in the background of a conventional slider. Colors may be used to represent every level of content descriptions and features. Also rules of color combination can be applied to define a representation of the video content at an emotional level or at a thematic level. The same principle could also be used on an audio signal so as to obtain a color.

For the extraction of the dominant color of a picture well known algorithms could be used such as:

The weighted average of the most frequent colors;

A clustering technique based on the generalized Lloyd algorithm (GLA);

The average color.

For the purpose of the color browser, the average color has given the best results and, compared to the other mentioned algorithms, it has lower computational costs.

When applied to the color slider, the dominant colors of successive video frames can present slight differences that create an annoying noise effect. To help the user in recognizing segments with a change in the content, the differences between successive very similar colors can be smoothed until the slider is divided into well distinct colored regions. FIG. 4 shows that the smoothing filter used in the lower slider eliminates the noise and it helps to distinguish between different program segments. To obtain this, it is possible to use a coarse quantization of the color space so that the slider displays only a limited range of colors. The main issue in applying this technique is the choice of the color space and of its discretization. A linear quantization is easy to compute but can lead to unacceptable results if the chosen color space lacks the property to be perceptually uniform. dominant colors of two successive frames are compared and if their distance is below a fixed threshold, they are averaged and the average value is used for the successive comparison. When the distance between the current average and a color is above the threshold, than a new cluster containing the last color is created. This algorithm has been implemented and tested for the RGB and the YC_{b}Cᵣ color spaces using the Euclidean distance to evaluate the color similarity. The YC_{b}Cᵣ color space has given the best results due to the fact that it is approximative perceptually uniform. The threshold used to discriminate if two colors are similar has been tuned by making experiments with broadcast TV programs. FIG. 3 gives an example of a color slider obtained using the dominant colors computed with the generalized Lloyd algorithm and the same slider after the application of the smoothing technique. Including a color in a cluster if Its distance from the average is below a certain threshold can lead to poor results if the colors change slowly. To get through this limitation, a more refined clustering algorithm can be applied (i.e. the generalized Llóyd algorithm). Instead of using the average of successive colors to decide to create a new color region in the slider, the sum of the distances from the average to all the colors in a region (total distortion) should be used. When this total distortion exceeds a threshold, than the region has to be split into two different colored areas. This approach is equivalent to apply the generalized Lloyd algorithm to the colors of the vertical stripes in the slider, with the additional constraint that the pixels in the clusters created by the GLA iterations have to belong to areas of adjacent stripes.

Some sliders obtained using the low cost algorithm of the average color present a lack of brightness and tend to brown or grey hues. This is due to the fact that in a simple average, all the colors are weighted evenly. If a more precise dominant color computation is used the results may not be better. What a human perceives as dominant color in an image is influenced by embedded semantic information that can not be easily modeled. However, to obtain a wider color range, a psychologically inspired model can be applied to weight colors according to the human perception.

Even if one dominant color per video frame seems to provide relatively poor information, experimental results demonstrate that it can be enough to create useful cues in broadcast TV programs. Formal tests about the usability of the color browser compared to other more traditional tools in video navigation and retrieval of specific segments are in progress. Tests have given promising results. The dominant color slide-bar allows users to see at a glance changes in the video content like, for example, breaks in football matches, because most of the slider's background will be green and during a break it will change drastically. Most of the colors are green hues that correspond to normal game actions. When something interesting is happening, often the cameras zoom on a player and the green is interrupted by brownish stripes.

Changes in different parts of video programs can be visualized effectively. The color slider enables a user to recognize at a glance the beginning of the match because it follows the headings and the report recorded in studio, which has another color in the slider bar. The color slider enables also the user to identify commercial breaks in a program. Often a commercial break is characterized by a high rate color change and the presence of black frames.

Users can find and decide to skip commercial breaks or can jump directly to the beginning or to a particular section of a program. Current commercial break detectors are still quite far from the reliability required by consumer products. A system provided with a color slider, let the decision to skip a commercial break to the users, thus it can never fail.

It has been found that users learn to recognize the pattern of the titles of their favorite series and they can jump directly to see what they want even if it is preceded by commercial breaks or other footage. Colors make a graphical interface more appealing and sometimes users just look at a particular color out of curiosity.

From the point of view of the user interaction, it is important to associate to the colors the absolute or relative time position within the total duration of the represented program. Since the color slider embodies information about frames into its background, its length is correlated to the duration of the video sequence. The number of frames associated to each distinct color determines the granularity of the slider. Giving users a fixed time scale for all the video segments, independently from their duration, has the advantage that people can learn to recognize patterns of colors within different programs. Users associate a physical length in the slider to a fixed amount of time and this helps in navigating through the video content. For example, titles of different episodes of the same program usually have predefined durations and if a fixed time scale is present, they will be associated to fixed lengths in the sliders.

To obtain a fixed time scale it is possible to use two color sliders of fixed lengths. FIG. 5 shows an embodiment with two color sliders. The first color slider 52 represents the whole video content, and could have different time scales for video segments of different durations. The second color slider 54 has preferably a fixed time scale for all the video segments and represents a zoomed-in portion 56 of the first bar. Together, the two sliders are called color browser. The user can interact with both sliders. By moving the cursor (window 56) of the slider that represents the whole content, the user can move with a coarse grade of granularity within a video clip. This means that a user can fly over a long video segment having a complete overview of the content with a very small effort and in a very short time. Once he has found a segment of interest, he can further explore it by using the wiper 58 in the second color slider.

The embodiments of the invention described above are related to browsing through video material. However the invention is also suitable for apparatuses for reproducing an audio signal such as a CD player. The apparatus for reproducing an audio signal according to the invention comprises a display unit for displaying the slider bar. The audio slider is a user interface component that is a representation of the audio track as a whole. The slider on the slider bar is an indication an indication of progress of the rendering process. It indicates as such at any given moment the relative position of the part of the audio track that the rendering process is handling at that time.

The audio slider bar can be used for navigating the audio track. By placing the slider in a certain position on the slider bar, e.g. by dragging it or operating slider navigation buttons, the rendering process can be moved to the position in the track that corresponds to the new relative position of the slider.

By adding visual parameters related to the audio features of subsequent parts of the audio signal a more meaningful representation of the audio track on the slider can aid the user in navigating the audio track and targeting specific parts of the audio track. A prerequisite is that some information on segments constituting the track is available. This information can be predetermined, user defined or generated on the spot, e.g. by audio feature mapping such as beat detection, contour mapping, pattern matching. Predetermined information can be delivered as part of an audio multiplex or in a separate data structure, e.g. a separate file. User defined or generated information can also be stored in the same manner depending on whether the application allows it.

The form of the visual parameter added to the audio slider bar could be static or dynamic.

A static visual parameter gives the slider bar a certain appearance that conveys the meaning. A first example of a slider bar with a static visual parameter is given in FIG. 6. An abstract interpretation of the audio track, e.g. indicating intro, stanza and chorus, superimposed on or integrated in the slider. In a second embodiment of a slider bar with a static visual parameter the intensity variations of colors and/or shades of the segments of the slider bar correspond to respective features (e.g. rhythm, integrated amplitude) in the audio. In a third embodiment of a slider bar, the slider bar is shaped in line with features in the audio. An example is given in FIG. 7.

When using a dynamic visual parameter the meaning is conveyed by something that is made visible as soon as the slider or pointing device points to a certain part of the slider without moving the slider. This could be done by pop-up icons or shapes that represent a feature or component currently being indicated. The background of the slider bar already distinguishes the individual segments in the audio signal. An embodiment is given in FIG. 8. FIG. 9 shows another embodiment of using the visual parameter dynamically. In this embodiment an area 92 of the slider bar is used to show by coloring, shading or morphing of an icon on the slider bar. It should be noted that instead of symbols that represents the segment, textual information could be used, p.e. intro, stanza, chorus etc. Also note that many other audio features, e.g. tempo, pitch can be used as a basis to add meaning to the slider bar.

CD-DA offers the option to index audio tracks. This indexing could be used to segment the audio tracks. This index makes it possible to jump immediately to the indexed points in an audio track. This segmentation in turn can be used to add meaning to an audio slider. This could be done by combining the index with a database, which comprises entries for the indexed segments and information related to the content of the segments. This database could be stored in a data part of the CD-DA, p.e. subcodes or data track after CD-DA content. However the database could also be supplied by a service providers via Internet or other suitable data carrier.

An MPEG multiplex offers the option to incorporate a frame index. Each entry in this index table could have additional information qualifying the audio from that point onward. A sample implementation would be an extended access table. The same qualified index could be stored alternatively in a separate file, a table of contents or a playlist. An embodiment of an implementation of a qualified MPEG time access table could be

| Syntax | | #bytes |
|---|---|---|
| CD2_linear_time_access_table( ) | | 2048 |
| { | | |
| | CD2_sector_header( ) | 32 |
| | CD2_audio_program_stream_sectors | 4 |
| | Reserved | 12 |
| | for ( i=0; i<500; 1++) | |
| | { | |

| | |
|---|---|
| frame_start_pointer | 4 |
| audio_qualifier( ) | 1 |

}

}

An implementation of the parameter audio_qualifier( ) could be:

| Syntax | | #bits |
|---|---|---|
| audio_qualifier( ) | | 8 |
| { | | |
| | section_start | 1 |
| | section_type | 3 |
| | section shade | 4 |

}

The parameters of the audio_qualifier parameter could be defined as follows:

section_start: indicates the beginning of a new section

| value | meaning |
|---|---|
| 0 | no change |
| 1 | new section commences |

section_type: indicates the section type

| value | meaning |
|---|---|
| 0 | reserved |
| 1 | intro |
| 2 | stanza |
| 3 | chorus |
| 4 | extro |
| 5 . . . 7 | reserved |

section_shade: indicates the section shade

| value | meaning |
|---|---|
| 0 | none |
| 1 | 100% white |
| 2 | 90% white, 10% black |
| . . . | |
| 6 | grey: 50% white, 50% black |
| . . . | |
| 10 | 10% white, 90% black |
| 11 | 100% black |
| 12 . . . 15 | reserved |

The data structure describes above could be stored on a record carrier such as an optical disk together with the information signal. The record carrier could be of a prerecorded type. The information signal and the data structure could be combined so as to obtain a transmission signal. The transmission signal could be transmitted via any suitable transmission medium, such as satellite connection, telephone line, cable connection.

Though the invention is described with reference to preferred embodiments thereof, it is to be understood that these are non-limitative examples. Thus, various modifications are conceivable to those skilled in the art, without departing from the scope of the invention, as defined by the claims. As an example, the background of the length display may be divided in an upper and a lower part. The upper part of a strip could represent the dominant color of the images corresponding to said strip and the lower part of the strip could represent the loudness of the sound corresponding to said strip. By combining the upper and the lower part the user could be able to find parts of the program more precise. The portions of the background could have other forms as a strip, so could the portions together give the user the impression that the background represents a sequence of planes. Furthermore, the attractiveness of the displayed colors of the browser could be improved by considering the luminance values that are below a certain threshold and it raises them above the threshold using a fixed or linear/non-linear way. The smoothing threshold of the slider can be implemented adaptive to the level of granularity. E.g. for a long sequence displayed in one slider, the smoothing factor should be increased to give a rough overview of the content stored. For a zoom into a part of the content, the smoothing factor should be decreased to show more fine details.

Audio and visual descriptors could be integrated into one color browser. One approach would be to control the luminance level by the volume level (or another audio descriptor), e.g. a high volume level results in a bright color region and the other way around. An alternative option would be to control one color parameter by the volume level, e.g. volume level pass over a certain threshold then the region will be displayed in a predefined unusual color.

In the case that genre information is available, i.e. from an electronic program guide, the color browser parameters (thresholds, descriptors, etc . . . ) could adapt to the specific genre, e.g. in a soccer game, because the dominant colors are green hues, non-green colors will be highlighted.

The generation of dominant colors could be improved by weighting the color information according to its position in the video frames. Because the centre of the frames mainly attracts human observers, colors in the central area of each video frame could be weighted more than colors in the peripheral areas.

The object of interest is most of the time moving in the foreground. The background is of lower importance for the viewer. By applying image segmentation techniques to the video frames, it could be possible to extract separate descriptors for background and foreground. The color browser could then display only the foreground information or a weighted sum of both features.

Another possibility is to divide horizontally the slider into two regions: one will display the foreground descriptors and the other one the background features. In order to separate background and foreground, instead of applying expensive object segmentation techniques to every video frame, when the video material is compressed in MPEG format, it is possible to use embedded motion information. For MPEG 1 and MPEG 2 digital video formats it is possible to use the motion vectors coded for P and B frames. For MPEG 4 digital video format it is possible to use directly information about the objects present in the scenes. In the event motion vectors are used, the background of the slider bar could be indicative for the amount of movement in a scene. This embodiment enables the user to distinguish calm and boisterous scenes.

The user interaction with the color browser is based on moving the cursors that indicate the current position in the audio-video segment. If a pointer device (e.g. mouse, touch screen) is not available, the interaction can be limited to the use of forward/backward buttons (e.g. of a remote control). When the user keep pressing the forward/backward button, the speed of the cursor can depend on the uniformity of the colors. In a uniform colored region the cursor will be accelerated until it reaches a different color region.

The user can adjust the zoom level of the two sliders of the color browser with two additional controls: zoom in and zoom out. In this way users can decide to browse through the audio-video content at different levels of granularity.

The color browser can be enhanced with additional icons that highlight particular events that could appear during the scrolling. Examples of such events can be goals in football matches, scene changes, violent scenes, action scenes, erotic scenes, etc. It could be even possible to apply a face detection algorithm and to show an icon representing the face of the current actor playing a scene. In stead of icons of course the actors could be indicated by different colors in the slider.

Instead of using pop-up icons to include further descriptors in the browser, it could be possible to code these descriptors with colors and to show them in horizontal bars below or above the normal sliders. These bars or markers could further indicate to a user changes in the scenes, commercial blocks, erotic scenes, violent scenes, etc.

The use of the verb “to comprise” and its conjugations does not exclude the presence of elements or steps other than those stated in a claim. Furthermore, the use of the article “a” or “an” preceding an element does not exclude the presence of a plurality of such elements. In the claims, any reference signs placed between parenthesis shall not be construed as limiting the scope of the claims. The invention may be implemented by means of hardware as well as software. Several “means” may be represented by the same item of hardware. Furthermore, the invention resides in each and every novel feature or combination of features.

1. An apparatus for reproducing an ordered information unit, said apparatus having presentation generator means for generating a length display of the information unit on a display unit, said length display being divided in consecutive portions, a portion corresponds to a position in the information unit, said length display further comprises a marker, the apparatus further comprises user operable input means for receiving commands for moving the marker along the consecutive portions, means for determining the portion at which the marker is located, and means to enable reproduction of the information unit at the position indicated by the determined portion, characterized in that a portion of the length display has at least one visual parameter, said visual parameter representing a parameter having a relation with at least a part of the information unit corresponding to said portion.

2. An apparatus as claimed in claim 1, characterized in that the visual parameter is in the form of a color on a display unit.

3. An apparatus as claimed in claim 1 or 2, characterized in that the ordered information unit comprises a sequence of samples and the sequence of the samples corresponds to the consecution of the portions.

4. An apparatus as claimed in claim 1, 2 or 3, characterized in that ordered information unit comprises video information.

5. An apparatus as claimed in claim 4, characterized in that the visual parameter corresponds to a parameter determined from the color information of at least one image attached to the position indicated by the determined portion.

6. An apparatus as claimed in claim 5, characterized in that the visual parameter corresponds to the average color of at least one image attached to the position indicated by the determined portion.

7. An apparatus as claimed in claim 1, 2 or 3, characterized in that ordered information unit comprises audio information.

8. An apparatus as claimed in claim 7, characterized in that the visual parameter corresponds to a parameter determined from at least one audio sample of the audio information attached to the position indicated by the determined portion.

9. An apparatus as claimed in claim 8, characterized in that the visual parameter corresponds to the loudness of the audio information attached to the position indicated by the determined portion.

10. An apparatus as claimed in claim 1, characterized in that the apparatus further comprises means for receiving the at least one visual parameters of the consecutive portions via a transmission medium.

11. An apparatus as claimed in claim 1, characterized in that the apparatus further comprises means for determining the at least one visual parameter of the portions from the information unit.
